(19) United States
(12) Patent Application Publication
(10) Pub. No.: US 2014/0254431 A1
(43) Pub. Date: Sep. 11, 2014

(54) Advanced TDM Daisy-Chain Communication Systems and Devices

(71) Applicant: ANALOG DEVICES TECHNOLOGY, Hamilton (BM)

(72) Inventors: Dongqin Yan, Shanghai (CN); Yang Pan, Shanghai (CN); Olafur M. Josefsson, Hafnarfjordur (IS)

(73) Assignee: ANALOG DEVICES TECHNOLOGY, Hamilton (BM)

(21) Appl. No.: 13/790,071

(22) Filed: Mar. 8, 2013

(51) Int. Cl. H04L 12/24

(52) U.S. Cl. CPC H04L 41/12
USPC 370/255

(57) ABSTRACT

Advanced TDM daisy-chain configurations utilize data transmission over a frame sync signal path with feedback to allow for communication between the master device and slave devices and/or between individual slave devices while maintaining a simple TDM communication interface. In certain daisy-chain configurations, the feedback path returns to the frame sync signal path between the master device and the first slave device, which allows for transmission of data from the last slave device to the master device and/or to the first slave device. In other daisy-chain configurations, the feedback path returns to the frame sync signal path between the first slave device and the second slave device, which allows for transmission of data from the last slave device to the first slave device (which may transfer data to the master device, e.g., over separate command and/or data lines) and/or to the first slave device.

### CROSS-REFERENCE TO RELATED APPLICATION(S)

The subject matter of this patent application may be related to the subject matter of commonly-owned U.S. patent application Ser. No. ______ entitled DISTRIBUTED AUTOMATIC LEVEL CONTROL FOR A MICROPHONE ARRAY filed on even date herewith (Attorney Docket No. 2550/E15).

The subject matter of this patent application also may be related to the subject matter of commonly-owned U.S. patent application Ser. No. 13/426,918 entitled SYNCHRONIZATION, RE-SYNCHRONIZATION, ADDRESSING, AND SERIALIZED SIGNAL PROCESSING FOR DAISY-CHAINED COMMUNICATION DEVICES filed Mar. 22, 2012 (Attorney Docket No. 2550/D82), which claims the benefit of U.S. Provisional Patent Application No. 61/467,538 filed Mar. 25, 2011.

The subject matter of this patent application also may be related to the subject matter of commonly-owned U.S. patent application Ser. No. 13/071,836 entitled SYSTEM, APPARATUS, AND METHOD FOR TIME-DIVISION MULTIPLEXED COMMUNICATION filed on Mar. 25, 2011 (Attorney Docket No. 2550/D35), which is hereby incorporated herein by reference in its entirety.

Each of these patent applications is hereby incorporated herein by reference in its entirety.

### FIELD OF THE INVENTION

The present invention relates generally to time-division multiplexed communication systems and, more particularly, to an advanced time-division multiplexed communication system.

### BACKGROUND OF THE INVENTION

In certain communication systems, multiple devices transmit data to a controller via a communication channel (e.g., a single-wire bus) that is logically divided into a number of successive time slots, with each time slot having a predetermined number of bits. Each device transmits data to the controller in one or more designated time slots according to a slot allocation scheme, which is fixed in some communication systems and variable in other communication systems. Often times, the devices transmit at fixed regular intervals, and therefore the communication channel is often logically divided into a number of frames with each frame containing a predetermined number of time slots, and each device transmits in its respective time slot(s) in each frame. Thus, for example, a first device may transmit in the first time slot of each frame, a second device may transmit in the second time slot of each frame, and so on. In some systems, devices may transmit in multiple time slots, for example, a first device may transmit in the first and second time slots of each frame, a second device may transmit in the third and fourth time slots of each frame, and so on. In some systems, different devices may transmit in different numbers of time slots, for example, a first device may transmit in the first time slot of each frame, a second device may transmit in the second and third time slots of each frame, a third device may transmit in the fourth time slot of each frame, and so on.

For convenience, N will be used herein to represent the number of time slots per frame, B will be used herein to represent the number of bits per time slot, and M will be used herein to represent the number of devices. A particular embodiment might have, for example, eight 32-bit slots per frame (i.e., N=8, B=32), although the present invention is not limited to any particular values of N and B. The actual data transmitted in each time slot may use all B bits or may use fewer than all B bits (e.g., a 24-bit sample of digital audio may be conveyed in a 32-bit time slot). In various systems, there may be a one-to-one relationship between SCK and bits (e.g., one cycle of SCK for each bit) or there may be other relationships between SCK and bits (e.g., two or more cycles of SCK for each bit).

FIG. 1 schematically shows an exemplary system having a number of devices 104₁-104_{M} that transmit data to controller 102 in a TDM fashion, as known in the art. In this exemplary configuration, the controller acts as a bus master and all of the slaves operate as slave devices. The controller 102 provides a clock signal (SCK) and a frame synchronization signal (WS) to all of the devices 104. The controller 102 also sends commands to the devices 104 (e.g., based on a unique address for each device 104) over one or more command lines, for example, to configure the time slot(s) for each device 104 to transmit data over the data line (SD). Based on the SCK and FS signals, and the configuration information provided by the controller 102, each device 104 transmits in one or more designated time slots on the SD line.

FIG. 2 schematically shows another exemplary system having a number of devices 204₁-204_{M} that transmit data to controller 202 in a TDM fashion, as known in the art. In this exemplary system (which is similar to configurations shown and described in United States Publication US 2008/0069151 entitled “Variable Time Division Multiplex Transmission System” and filed by Satoh et al., which is hereby incorporated herein by reference in its entirety), each of the devices 204 includes both master operating logic and slave operating logic, and the operational mode of each device 204 may be set, for example, using a hardware pin on the device. In this exemplary embodiment, the first device 204₁ is set to operate as the bus master (e.g., via the M/S pin) and provides a clock signal to both the controller 202 and the other devices 204, which are set to operate as slave devices (e.g., via the respective M/S pin). The device 204₁ also provides a frame synchronization signal to the controller 202 to mark the start of each frame and provides a delayed synchronization signal to the second device 204₂ in the chain to mark the start of that device's time slot(s). Each slave device in the chain, beginning with the second device 204₂, provides a delayed frame synchronization signal to the next successive device in the chain.

### SUMMARY OF EXEMPLARY EMBODIMENTS

In one embodiment of the invention there is provided a time-division multiplexed communication system comprising a master device, a plurality of slave devices, and a data line coupled to the master device and to each of the slave devices. The master device and the plurality of slave devices are interconnected in a daisy-chain configuration. Each slave device includes a data pin coupled to the data line, a frame sync input, and a frame sync output, the frame sync input coupled to the frame sync output of the previous device in the daisy-chain configuration. Each slave device is configured to receive on its frame sync input a frame sync signal from the previous device in the daisy-chain configuration and to provide on its frame sync output a delayed frame sync signal. Each slave device is configured to transmit first data on the data line via its data pin in a predetermined time slot based on the frame sync signal received on its frame sync input. At least one slave device is configured to transmit second data on its frame sync output following transmission of the delayed frame sync signal.

In various alternative embodiments, at least one slave device may include a peripheral (e.g., a microphone), wherein at least one of the first data and the second data is based on data from the peripheral. The first data and/or the second data may be based on data from at least one other slave device received via the frame sync input. At least one slave device may include a processor configured to process data from the slave device and data received via the frame sync input.

In certain embodiments, the frame sync input of the first slave device in the chain configuration may be coupled to the frame sync output of a last slave device in the daisy-chain configuration, wherein the first slave device is configured to selectively receive, via its frame sync input, data transmitted on the frame sync output of the last slave device. In such embodiments, a frame sync output of the master device may be coupled to the frame sync input of the first slave device and may be further coupled to the frame sync output of the last slave device, wherein the master device may be configured to selectively receive, via its frame sync output, data transmitted on the frame sync output of the last slave device.

In certain other embodiments, the frame sync output of the first slave device in the chain configuration may be coupled to the frame sync output of the last slave device in the daisy-chain configuration, wherein the first slave device may be configured to selectively receive, via its frame sync output, data transmitted on the frame sync output of the last slave device and to selectively transmit data received from the last slave device to the master device. In such embodiments, the frame sync input of the second slave device in the daisy-chain configuration may be coupled to the frame sync output of the first slave device and may be further coupled to the frame sync output of the last slave device, wherein the second slave device may be configured to selectively receive, via its frame sync input, data transmitted on the frame sync output of the last slave device.

In any of the above embodiments, each slave device may be configured to selectively receive, via its frame sync input, data transmitted on the frame sync output of the previous device in the daisy-chain configuration. Additionally or alternatively, the master device may be coupled to the frame sync output of the last slave device (e.g., via its frame sync output or via a separate input), wherein the master device may be configured to selectively transmit, via its frame sync output, data received from the frame sync output of the last slave device.

In another embodiment there is provided a slave device for operation in a time-division multiplexed communication system having a master device and a plurality of slave devices interconnected in a daisy-chain configuration and having a data line coupled to the master device and to each of the slave devices. The slave device includes a data pin for coupling to the data line, a frame sync output, and a frame sync input for coupling to a frame sync output of a previous device in the daisy-chain configuration. The slave device is configured to receive on its frame sync input a frame sync signal from the previous device in the daisy-chain configuration and to provide on its frame sync output a delayed frame sync signal. The slave device is also configured to transmit first data on the data line via its data pin in a predetermined time slot based on the frame sync signal received on its frame sync input. The slave device is also configured to transmit second data on its frame sync output following transmission of the delayed frame sync signal.

In various alternative embodiments, the slave device may further include a peripheral (e.g., a microphone), wherein at least one of the first data and the second data is based on data from the peripheral. The slave device may be configured to selectively receive, via its frame sync input, data transmitted on the frame sync output of the previous device in the daisy-chain configuration. The first data and/or the second data may be based on data received via the frame sync input. The slave device may include a processor configured to process data from the slave device and data received via the frame sync input.

In certain embodiments, the frame sync input of the slave device may be couplable to the frame sync output of a last slave device in the daisy-chain configuration, wherein the slave device may be configured to selectively receive, via its frame sync input, data transmitted on the frame sync output of the last slave device.

In certain embodiments, the frame sync output of the slave device may be couplable to the frame sync output of a last slave device in the daisy-chain configuration, wherein the slave device may be configured to selectively receive, via its frame sync output, data transmitted on the frame sync output of the last slave device and to selectively transmit data received from the last slave device to the master device.

In another embodiment there is provided a master device for operation in a time-division multiplexed communication system having the master device and a plurality of slave devices interconnected in a daisy-chain configuration and having a data line coupled to the master device and to each of the slave devices. The master device includes a data pin couplable to the data line and a frame sync output couplable to a frame sync input of a first slave device in the daisy-chain configuration. The master device is configured to transmit a frame sync signal on its frame sync output. Additionally, the master device may be further configured to transmit data for at least one slave device via its frame sync output following the frame sync signal and/or may be further configured to selectively receive, via its frame sync output, data transmitted on a frame sync output of a last slave device in the daisy-chain configuration coupled to the frame sync output of the master device.

In various alternative embodiments, the master device may include an input separate from the frame sync output and couplable to the frame sync output of the last slave device, wherein the master device is configured to receive data from the last slave device via the input and to selectively transmit the data via its frame sync output.

Additional embodiments may be disclosed and claimed.

### BRIEF DESCRIPTION OF THE DRAWINGS

The foregoing and advantages of the invention will be appreciated more fully from the following further description thereof with reference to the accompanying drawings wherein:

FIG. 1 is a schematic block diagram showing an exemplary system having a number of devices that transmit data to a controller in a TDM fashion, as known in the art;

FIG. 2 is a schematic block diagram showing another exemplary system having a number of devices that transmit data to a controller in a TDM fashion, as known in the art;

FIG. 3 is a schematic block diagram showing a TDM daisy-chain configuration that forms the basis for various advanced TDM daisy-chain embodiments of the present invention;

FIG. 4 is a schematic block diagram showing a TDM daisy-chain configuration in which separate command lines and/or data lines are run between the master device and each of the slave devices;

FIG. 5 is a schematic block diagram showing an advanced TDM daisy-chain configuration in accordance with a first exemplary embodiment;

FIG. 6 and FIG. 7 are schematic diagrams showing simplified timing diagrams for initialization of an advanced TDM daisy-chain configuration of the type shown in FIG. 5 having eight slave devices, in accordance with two exemplary embodiments;

FIG. 8 is a schematic block diagram showing an advanced TDM daisy-chain configuration in accordance with a second exemplary embodiment;

FIG. 9 and FIG. 10 are schematic diagrams showing simplified timing diagrams for initialization of an advanced TDM daisy-chain configuration of the type shown in FIG. 8 having eight slave devices, in accordance with two exemplary embodiments;

FIG. 11 is a schematic block diagram showing relevant components of a slave device, in accordance with one exemplary embodiment;

FIG. 12 is a schematic block diagram showing an alternative advanced TDM daisy-chain configuration based on FIG. 5, in accordance with another exemplary embodiment;

FIG. 13 is a schematic block diagram showing an alternative advanced TDM daisy-chain configuration based on FIG. 8, in accordance with another exemplary embodiment; and

FIG. 14 is a schematic block diagram showing another alternative advanced TDM daisy-chain configuration based on FIG. 5, in accordance with another exemplary embodiment.

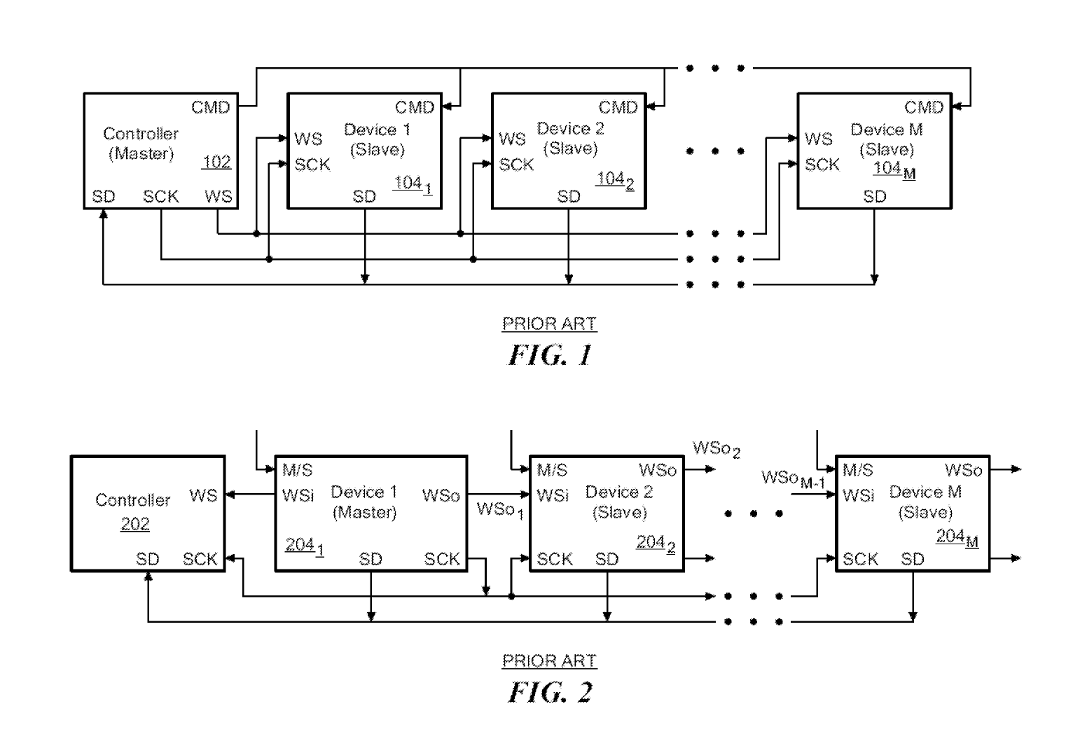

It should be noted that the foregoing figures and the elements depicted therein are not necessarily drawn to consistent scale or to any scale. Unless the context otherwise suggests, like elements are indicated by like numerals.

### DETAILED DESCRIPTION OF SPECIFIC EMBODIMENTS

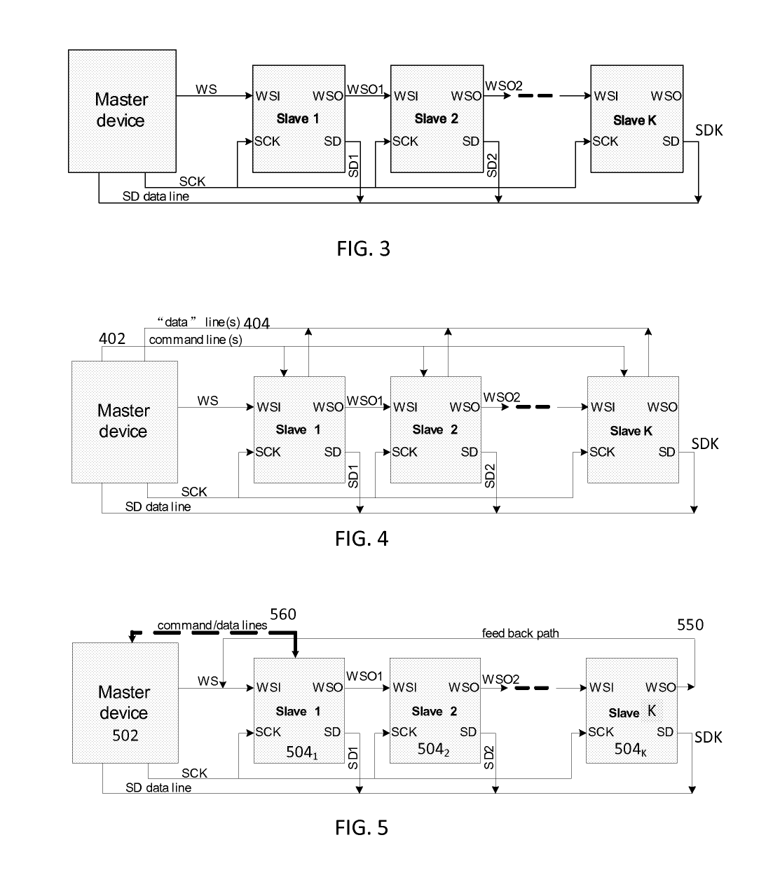

Embodiments of the present invention include various advanced TDM daisy chain configurations allowing for communications between the master device (also referred to as a “controller”) and the slave devices and/or between slave devices. Various exemplary embodiments described below are based on the TDM daisy-chain configuration shown in FIG. 3, aspects of which are described in U.S. patent application Ser. No. 13/071,836 and in U.S. patent application Ser. No. 13/426,918, although exemplary embodiments are adapted to allow for communications between the master device and slave devices and/or between slave devices independently of the TDM data carried on the SD line, by using the WS path for at least some of the data communications. Among other things, such data communications via the WS path allows the devices to exchange any of various types of information (e.g., command/control information, status information, raw or processed data, remote bus communications, etc.) while raw or processed TDM data is being transmitted via the SD line.

FIG. 4 is a schematic block diagram showing a TDM daisy-chain configuration in which separate command lines 402 and/or data lines 404 (e.g., and I2C bus) are run between the master device and each of the slave devices, allowing for such things as reading back status or other data from the slave devices, sending commands to slave devices, or communication between slave devices (e.g., via the master device).

In exemplary embodiments of the present invention, however, such communication is provided at least in part by a feedback line in which the WSO pin of the last slave device is fed back to one or more upstream devices (e.g., to the WS line between the master device and the first slave device or to the WS line between the first slave device and the second slave device). The WSO pin of an upstream device connected to the feedback line (e.g., the WS pin of the master device or the WSO pin of the first slave device in the daisy-chain) may, in certain embodiments, be configured to operate as an input-output pin allowing for both transmission of information (e.g., a frame clock signal and/or commands or data for one or more slave devices) and reception of information from the last slave device via that WSO pin. Each slave device transmits data to the next successive slave device using its WSO pin, in addition to transmission of the frame clock signal. In this way, each slave device still contains four pins for the TDM interface, and communications between the master device and the slave devices and/or communications between slave devices can be accomplished at least in part via the feedback line. Such communications can be used for a variety of applications, including, for example, distributed signal processing functions performed by the slave devices in which one or more of the slave devices processes data provided from other slave device(s).

In the context of the present invention, “data” transmitted by the master device and/or by a slave device via the WS line in addition to the frame sync signal may include, without limitation, control information (e.g., commands or configuration information from the master device to one or more slave devices), status information, data samples being sent to or from a slave device (e.g., raw or processed data samples, such as from a microphone or other sensor or converter), data being “tunneled” over the daisy-chain (e.g., I2C data between the master device and a remote I2C bus coupled to one of the slave devices), or other data as may be used in a particular implementation.

### Exemplary Embodiments 1

FIG. 5 is a schematic block diagram showing an advanced TDM daisy-chain configuration in accordance with a first exemplary embodiment. Compared to the TDM daisy-chain configuration shown in FIG. 3, a feedback line 550 connects the WSO pin of the last slave device (504_{K}) to the line between the WS pin of the master device 502 and the WSI pin of the first slave device 504₁. The last slave device 504_{K} transmits data from one or more upstream slave devices and/or from itself via the feedback line 550 to the first slave device 504₁ and/or the master device 502.

In certain embodiments, the WS pin of the master device 502 is an input-output pin that can be selectively configured to operate as an input to receive data from the last slave device 504_{K} and as an output to transmit the frame clock signal and other data to the first slave device 504₁ (e.g., commands, data from the master device, data from one or more slave devices received via the feedback line 550). In such embodiments, the command/data lines 560 may be omitted, as the master device 502 can transmit and receive data via its WS pin.

In certain other embodiments, the WS pin of the master device 502 is an output-only pin for transmitting the frame clock signal and other data (e.g., commands, data from the master device, data from one or more slave devices received via the feedback line 550), in which case the master device 502 receives data from the last slave device 504_{K} forwarded by the first slave device 504₁ over command/data lines 560.

In certain other embodiments, the WS pin of the master device 502 is an input-output pin that can be selectively configured to operate as an input to receive data from the last slave device 504_{K} and as an output to transmit the frame clock signal, while the master device 502 transmits data to the first slave device 504₁ (e.g., commands, data from the master device, data from one or more slave devices received via the feedback line 550) via the command/data lines 560 rather than via the WS pin.

In certain other embodiments, the WS pin of the master device 502 is an output-only pin for transmitting the frame clock signal, while the master device 502 transmits data (e.g., commands, data from the master device, data from one or more slave devices received via the feedback line 550) to the first slave device 504₁ via the command/data lines 560 and also receives data from the last slave device 504_{K} forwarded by the first slave device 504₁ over command/data lines 560. In such embodiments, the WS circuitry of the master device 502 is kept simple, as it is not used to transmit data or receive data.

In certain embodiments, the first slave device 504₁ may selectively receive data directly from the last slave device 504_{K} via the feedback line 550. Additionally or alternatively, in certain embodiments, the first slave device 504₁ may selectively receive data from the last slave device 504_{K} transferred by the master device via the WS pin or via the command/data lined 560.

In any case, each slave device selectively transmits a frame clock signal and other data to the next successive device via its WSO pin. Such data may originate from the master device, an upstream slave device, a downstream slave device, or from the slave device itself. Thus, for example, data (e.g., a command) may be passed along from the master device to one or more slave devices and data (e.g., a response) may be passed along back to the master device, or data may be passed from one slave device to another slave device (e.g., from an upstream slave device to a downstream slave device, or from a downstream slave device to an upstream slave device either through the master device or bypassing the master device).

Thus, the configurations shown in FIG. 5 and discussed above essentially form various types of communication loops that allow for bi-directional communications between the master device and the slave devices and between individual slave devices, where the communications between slave devices is unidirectional via the respective WSO pins.

Advanced TDM daisy-chain configurations of the types shown in FIG. 5 and discussed above may be initialized using a three-stage initialization sequence, substantially as described in U.S. patent application Ser. No. 13/426,918.

For example, in a synchronization stage, each slave device would receive a frame signal at its WSI pin and output the frame signal at its WSO pin with one time slot delay. The first slave device 504₁ receives the frame signal from the master device 502. The frame signal could be a simple pulse or could be a more complex sequence. During this stage, all the slave devices would be synchronized to the frame clock of the master device 502 and generate the frame clock by itself. This stage could take more than one frame period. In certain embodiments in which the master device 502 does not transmit data via its WS pin, the master device 502 may maintain the WS pin at a high impedance (Hi-Z) between frame signals in order to avoid conflict with the feedback signal from the last slave device 504_{K}.

During a second stage, addresses may be assigned to the slave devices. This stage may be optional in certain embodiments, although address assignment may be useful for many applications. Addresses may be assigned, for example, substantially as described in U.S. patent application Ser. No. 13/426,918.

After address assignment (or in lieu of address assignment), the slave devices would enter normal operation in which each slave transmits TDM data via the SD pin in a designated time slot, and other data may be received via the WSI pin (or, in the case of the first slave device 504₁, additionally or alternatively via the command/data lines 560) and/or transmitted via the WSO pin (or, in the case of the first slave device 504₁, additionally or alternative via the command/data lines 560). Assuming that the master device 502 receives data from the last slave device 504_{K} via its WS pin, the master device will configure its WS pin as an input during the time slot in which the last slave device transmits data on its WSO pin.

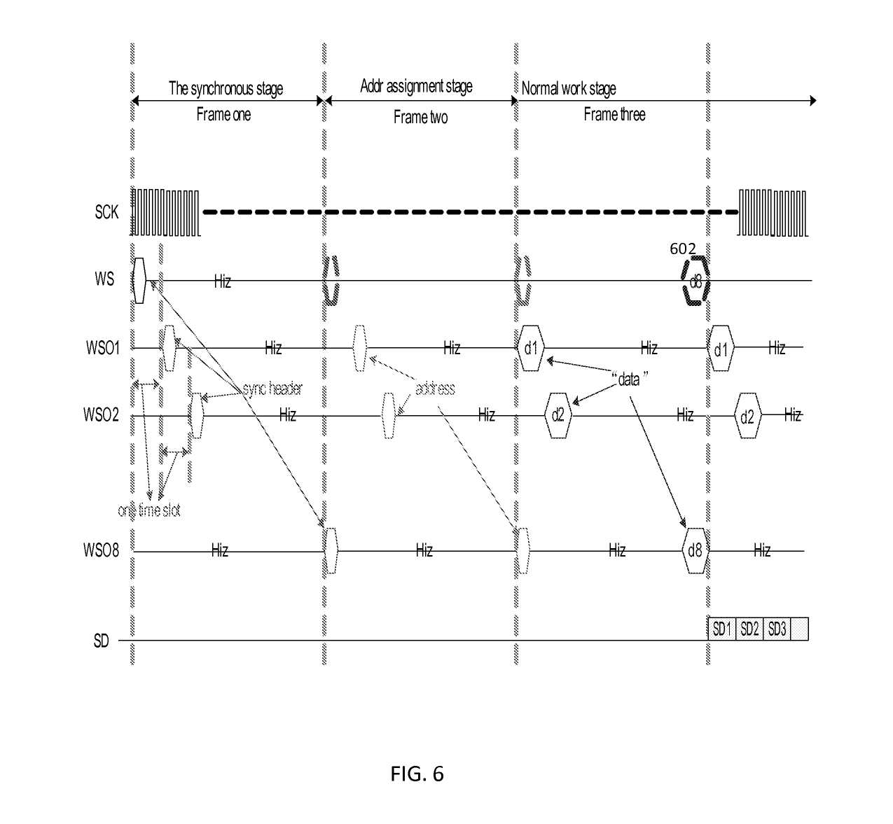

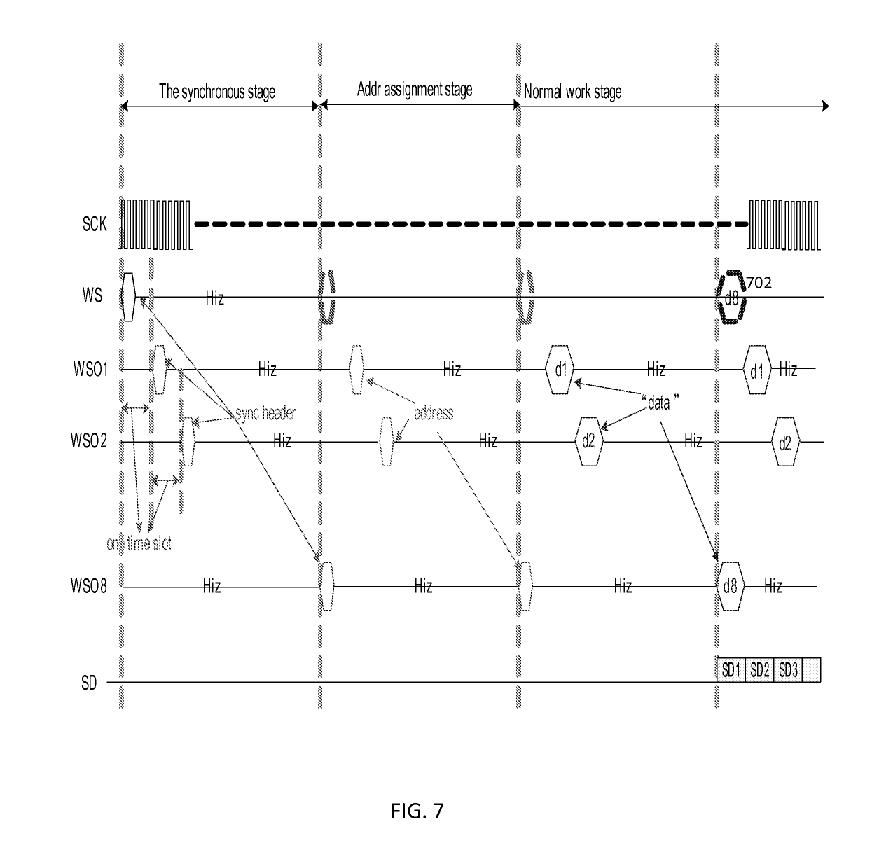

FIG. 6 and FIG. 7 are schematic diagrams showing simplified timing diagrams for initialization of an advanced TDM daisy-chain configuration of the type shown in FIG. 5 having eight slave devices, in accordance with two exemplary embodiments. In FIG. 6, during the normal operation stage, each slave transmits TDM data via its SD pin in a designated time slot and optionally also transmits data via its WSO pin in a corresponding time slot, and the master device may configure its WS pin as an input during the last time slot 602 to receive data from the last slave device. In FIG. 7, during the normal operation stage, each slave device does not transmit data via its WSO pin in synchronization with its TDM data transmitted via its SD pin (in this example, transmission of data via the WSO pin is delayed by one time slot from the transmission of data via the SD pin, although other embodiments may use other timing relationships), and the master device may configure its WS pin as an input during the time slot 702 to receive data from the last slave device. Additionally or alternatively, the first slave device may receive the data from the last slave device via its WSI pin during the time slot in which the last slave device transmits data on its WSO pin.

It should be noted that the present invention is not limited to these or to any particular sequences nor to any particular number of slave devices, which may be less than or greater than eight.

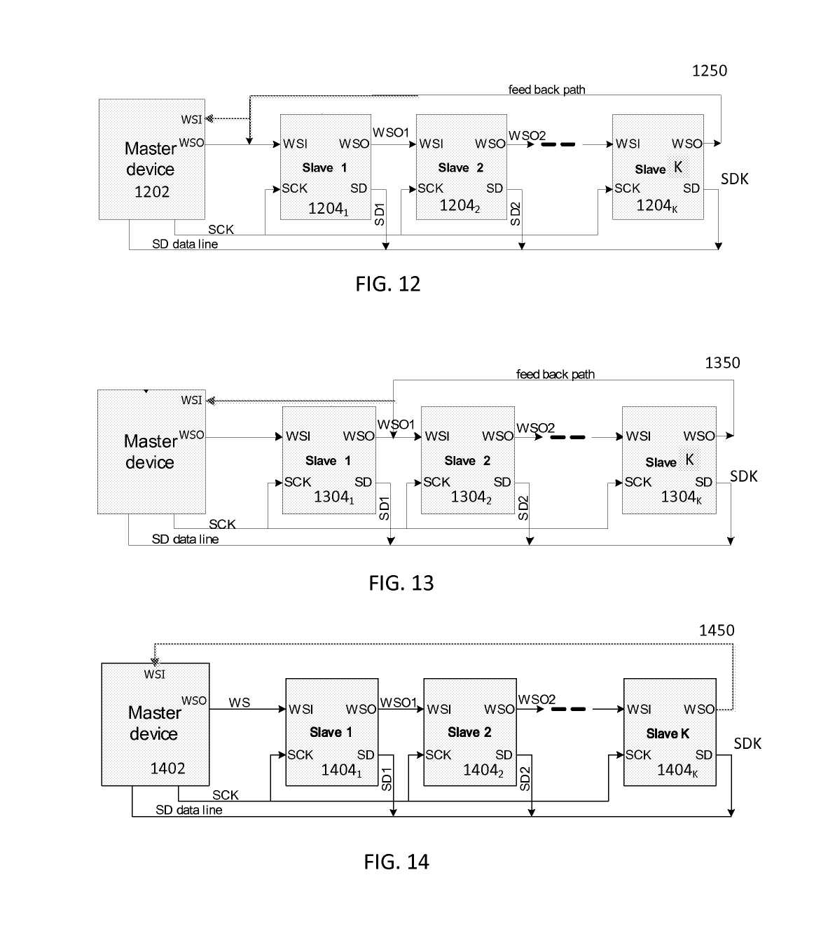

FIG. 12 is a schematic block diagram showing an alternative advanced TDM daisy-chain configuration based on FIG. 5, in accordance with another exemplary embodiment. Here, the feedback path 1250 from the last slave device 1204_{K} is coupled to the line between the WSO pin of the master device 1202 (which then may be an output-only pin) and the WSI pin of the first slave device 1204₁, and the feedback path 1250 is also coupled to a separate WSI pin of the master device 1202 that allows the master device 1202 to receive data from the last slave device 1204_{K} via the feedback line 1250.

FIG. 14 is a schematic block diagram showing another alternative advanced TDM daisy-chain configuration based on FIG. 5, in accordance with another exemplary embodiment. Here, the feedback path 1450 from the last slave device 1404_{K} is coupled to a separate WSI pin of the master device 1402 that allows the master device 1402 to receive data from the last slave device 1404_{K} via the feedback line 1450. The master device 1402 then can selectively forward data received from the last slave device 1404_{K} as needed to the other slave devices in the daisy-chain configuration via its WSO pin, e.g., to allow for communication from a downstream slave device to an upstream slave device.

### Exemplary Embodiments 2

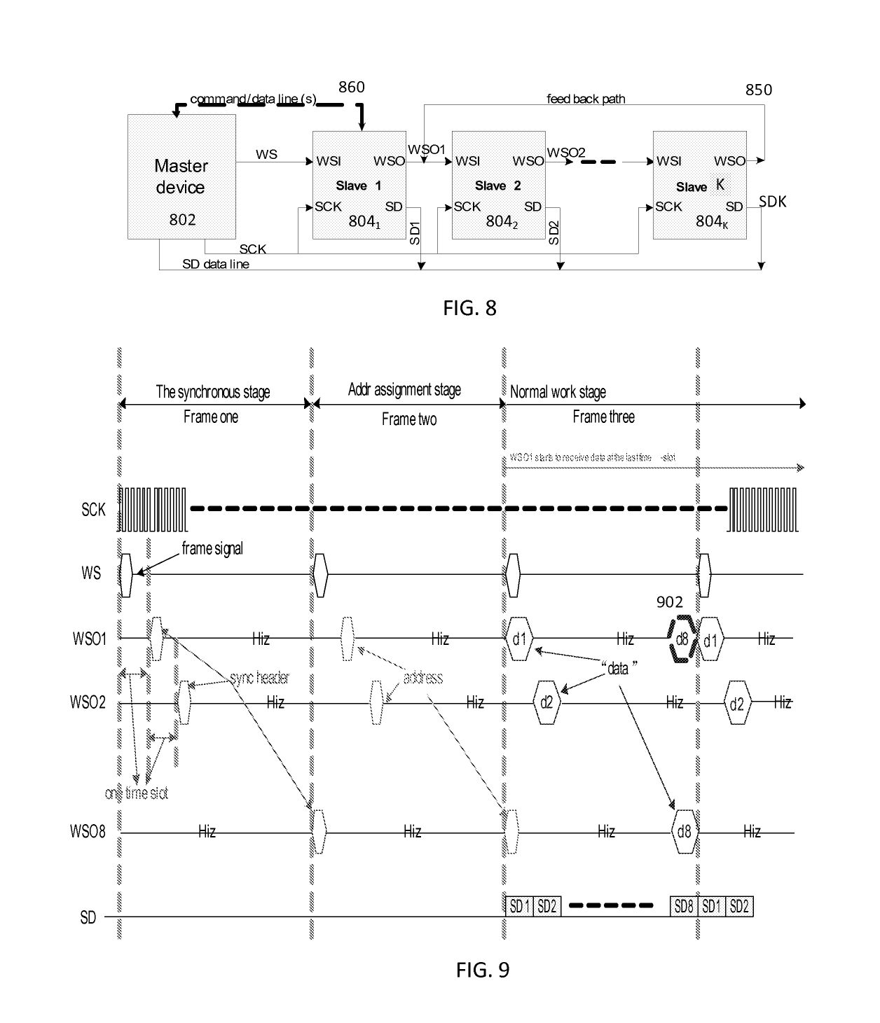

FIG. 8 is a schematic block diagram showing an advanced TDM daisy-chain configuration in accordance with a second exemplary embodiment. Compared to the TDM daisy-chain configuration shown in FIG. 5, a feedback line 850 connects the WSO pin of the last slave device (804_{K}) to the line between the WSO pin of the first slave device 804₁ and the WSI pin of the second slave device 804₂. The last slave device 804_{K} transmits data from one or more upstream slave devices and/or from itself via the feedback line 850 to the first slave device 804₁ and/or the second slave device 804₂. The WSO pin of the first slave device 804₁ is an input-output pin that can be selectively configured to operate as an input to receive data from the last slave device 804_{K} and as an output to transmit a frame clock signal and other data to the second slave device 804₂. The first slave device 804₁ selectively transmits data received from the last slave device 804_{K} to the master device 802 via the command/data lines 860. Since the master device 802 does not need to receive data via is WS pin, the WS pin of the master device 802 may be an output-only pin for transmitting the frame clock signal, and in certain embodiments, also data (although the master device 802 additionally or alternatively may transmit data via the command/data lines 860 in various alternative embodiments).

As in the embodiments described above with reference to FIG. 5, each slave device selectively transmits a frame clock signal and other data to the next successive device via its WSO pin. Such data may originate from the master device, an upstream slave device, a downstream slave device, or from the slave device itself. Thus, for example, data (e.g., a command) may be passed along from the master device 802 to one or more slave devices, and data (e.g., a response) may be passed along back to the master device 802, or data may be passed from one slave device to another slave device (e.g., from an upstream slave device to a downstream slave device, or from a downstream slave device to an upstream slave device either through the master device or bypassing the master device). In certain embodiments utilizing the configuration shown in FIG. 8, the second slave device 804₂ may receive data directly from the last slave device 804_{K} via the feedback line 860.

Thus, the configurations shown in FIG. 8 and discussed above essentially form various types of communication loops that allow for bi-directional communications between the master device and the slave devices and between individual slave devices, where the communications between slave devices is unidirectional via the respective WSO pins.

Advanced TDM daisy-chain configurations of the types shown in FIG. 8 and discussed above may be initialized using a three-stage initialization sequence, similar to those shown in FIGS. 6 and 7. However, in certain embodiments, during initialization (e.g., during the address assignment stage), the first slave device typically is flagged as being special. Then, each slave device would check if it is the first one (e.g., when entering the normal operation stage). If it is not, it will just receive data at its WSI pin and output data on its WSO pin; if it is, it will configure its WSO pin as an input during the time slot in which the last slave device 804_{K} transmits data on its WSO pin.

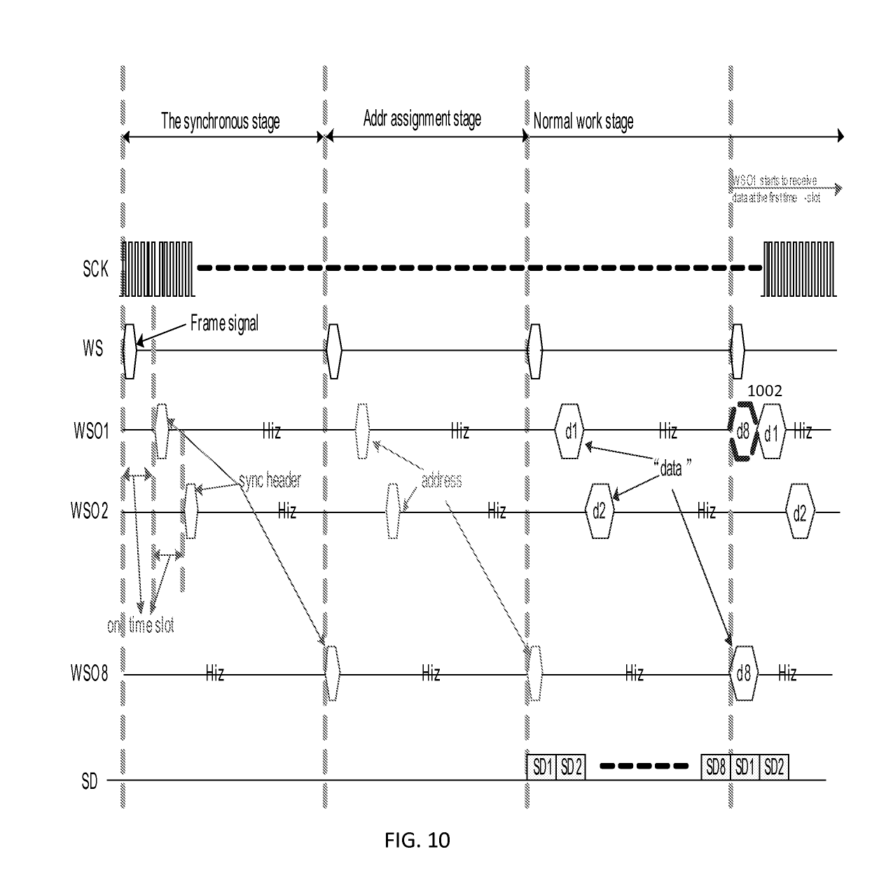

FIG. 9 and FIG. 10 are schematic diagrams showing simplified timing diagrams for initialization of an advanced TDM daisy-chain configuration of the type shown in FIG. 8 having eight slave devices, in accordance with two exemplary embodiments. In FIG. 9, during the normal operation stage, each slave transmits TDM data via its SD pin in a designated time slot and optionally also transmits data via its WSO pin in a corresponding time slot, and the first slave device typically configures its WSO pin as an input during the last time slot 902 in which the last slave device transmits data on its WSO pin. In FIG. 10, during the normal operation stage, each slave device does not necessarily transmit data via its WSO pin in synchronization with its TDM data transmitted via its SD pin (in this example, transmission of data via the WSO pin is delayed by one time slot from the transmission of data via the SD pin, although other embodiments may use other timing relationships), and the first slave device typically configures its WSO pin as an input during the time slot 1002 in which the last slave device transmits data on its WSO pin. Additionally or alternatively, the second slave device may receive the data from the last slave device via its WSI pin during the time slot in which the last slave device transmits data on its WSO pin.

It should be noted that the present invention is not limited to these or to any particular sequences nor to any particular number of slave devices, which may be less than or greater than eight.

In certain exemplary embodiments described above with reference to FIG. 8, only the first slave device in the chain 804₁ would need to have its WSO pin operate as an input-output pin, while the WSO pin of the other slave devices may be output-only. The functionality of the WSO pin could be hard-wired in the slave devices, i.e., the first slave device could be hard-wired with the WSO pin as an input-output pin, while the other slave devices could be hard-wired with the WSO pin as an output-only pin; such configuration would be beneficial, for example, where multiple slave devices are produced in a single product such that the positions of the slave devices are fixed. Alternatively, all slave devices may be capable of operating the WSO pin as an input-output pin and the input-output capability may be selectable, such as based on the position of the slave device in the chain; this capability would be beneficial, for example, where the slave devices are produced in such a way that they can be placed in any location in the chain (e.g., when the slave devices are individual parts that can be connected to other parts).

FIG. 13 is a schematic block diagram showing an alternative advanced TDM daisy-chain configuration based on FIG. 8, in accordance with another exemplary embodiment. Here, the feedback path 1350 from the last slave device 1304_{K} is coupled to the line between the WSO pin of the first slave device 1304₁ and the WSI pin of the second slave device 1304₂, and the feedback path 1350 is also coupled to a separate WSI pin of the master device 1302 that allows the master device 1302 to receive data from the last slave device 1304_{K} via the feedback line 1350.

### Exemplary Communication Scenarios

As discussed above, the advanced TDM daisy-chain configurations of FIG. 5 and FIG. 8 allow for communications between the master device and slave devices and/or between slave devices, including unidirectional communications and/or bi-directional communications. Such communications could be used in a wide variety of ways and for a wide variety of functions. Among other things, and without limitation, communications could be used for sending commands to the slave devices (e.g., a universal reset command sent by the master device), for a command/response protocol (e.g., the master could send a command to all slave devices, a group of slave devices, or an individual slave device, which could respond back to the master device, such as with status data), or for distributed processing by the slave devices (e.g., where one slave device operates on data from another slave device optionally in conjunction with processing of its own data), to name but a few. Distributed processing by the slave devices can be used to offload processing from the master device by allowing the slave devices to generate output(s) based on the data from one or more other slave device(s), such as for beamforming, noise reduction/cancellation, acoustic source localization, selective microphone muting, distributed automatic level control ALC (e.g., as described in the patent application entitled DISTRIBUTED AUTOMATIC LEVEL CONTROL FOR A MICROPHONE ARRAY incorporated by reference above), to name but a few. Data transmitted from one slave device to another could include “raw” data (e.g., unprocessed data) from the slave, processed data (e.g., data from the slave processed locally or processed based on data generated by one or more other slave devices), combined data (e.g., data from the slave combined with data from one or more other slaves), or other data (e.g., data based on data from the slave and/or one or more other slaves, such as a maximum value across the entire chain). It should be noted that the advanced TDM daisy-chain configurations described herein are not limited to any particular operation or use.

Each slave device may include one or more peripherals that produce data transmission by the slave device via the daisy-chain (in raw form and/or after processing by the slave device) and/or that consume data received by that slave device via the daisy-chain (in raw form and/or after processing by the slave device). For example, and without limitation, peripherals may include such things as a processor (e.g., a digital signal processor) that may produce data and/or consume data, one or more devices that produce data (e.g., microphone, accelerometer, gyroscope, analog-to-digital converter, etc.), one or more devices that are controllable via the daisy-chain (e.g., an audio output, a status light, a switch, a digital-to-analog converter, etc.), one or more communication ports over which data can be transferred to/from the daisy-chain (e.g., an I2C bus port allowing for remote I2C communication via the daisy-chain), etc. The present invention is not limited to any particular type(s) of peripherals supported by the slave devices, and it should be noted that different slave devices may support different peripheral(s). Thus, from the perspective of peripherals, certain slave devices may be “input-only” devices that generate data (e.g., a slave device having a microphone), certain slave devices may be “output-only” devices that consume data (e.g., a slave device having an audio output), and certain slave devices may be “input-output” devices (e.g., a slave device having both a microphone and a speaker).

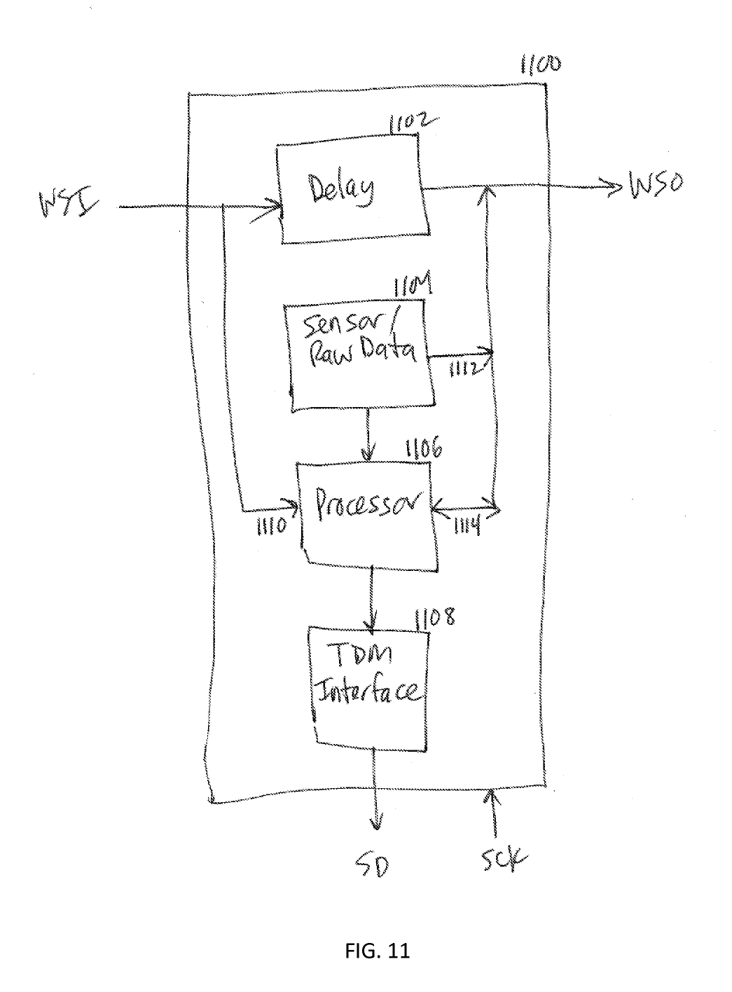

FIG. 11 is a schematic block diagram showing relevant components of a slave device 1100, in accordance with one exemplary embodiment. Among other things, this slave device 1100 includes a delay circuit 1102 that produces the delayed frame clock signal from WSI to WSO, a sensor or other source of raw data 1104, a processor 1106 that may process the raw data 1104, a TDM interface 1108 that transmits data via the SD line, which may be raw data and/or processed data. The slave device 1100 generally also includes a clock circuit (not shown) that generates internal clock(s) for the various other components of the slave device based on the SCL and WSI signals (where certain internal clock signals may be synchronized with corresponding clock signals of one or more other slave devices as described in U.S. patent application Ser. No. 13/426,918). As discussed above, in certain embodiments, data may be received via the WSI pin; such data may be routed to the processor 1106 via the line 1110 for processing and/or may be routed to another component of the slave device. Also, as discussed above, in certain embodiments, data may be transmitted via the WSO pin, for example, raw data from block 1104 via line 1112 and/or processed data from the processor 1106 via line 1114. Also, as discussed above, in certain embodiments, data may be received via the WSO pin; such data may be routed to the processor 1106 via line 1114 and/or may be routed to another component of the slave device. In embodiments in which data is received over the WSO pin, the WSO pin may be an input-output pin that is configured as an input to receive data from the WSO pin and is configured as an output to transmit the delayed clock signal and optionally data, for example, by the processor 1106 or other component of the slave device.

### Miscellaneous

It should be noted that headings are used above for convenience and are not to be construed as limiting the present invention in any way.

Various aspects of the present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. Computer program logic implementing some or all of the described functionality is typically implemented as a set of computer program instructions that is converted into a computer executable form, stored as such in a computer readable medium, and executed by a microprocessor under the control of an operating system. Hardware-based logic implementing some or all of the described functionality may be implemented using one or more appropriately configured FPGAs.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web). Of course, some embodiments of the invention may be implemented as a combination of both software (e.g., a computer program product) and hardware. Still other embodiments of the invention are implemented as entirely hardware, or entirely software.

The present invention may be embodied in other specific forms without departing from the true scope of the invention. Any references to the “invention” are intended to refer to exemplary embodiments of the invention and should not be construed to refer to all embodiments of the invention unless the context otherwise requires. The described embodiments are to be considered in all respects only as illustrative and not restrictive.

What is claimed is:

1. A time-division multiplexed communication system comprising:
a master device;
a plurality of slave devices; and
a data line coupled to the master device and to each of the slave devices, wherein:
the master device and the plurality of slave devices are interconnected in a daisy-chain configuration;
each slave device includes a data pin coupled to the data line, a frame sync input, and a frame sync output, the frame sync input coupled to the frame sync output of the previous device in the daisy-chain configuration;
each slave device is configured to receive on its frame sync input a frame sync signal from the previous device in the daisy-chain configuration and to provide on its frame sync output a delayed frame sync signal;
each slave device is configured to transmit first data on the data line via its data pin in a predetermined time slot based on the frame sync signal received on its frame sync input; and
at least one slave device is configured to transmit second data on its frame sync output following transmission of the delayed frame sync signal.

2. A system according to claim 1, wherein at least one slave device includes a peripheral, and wherein at least one of the first data and the second data is based on data from the peripheral.

3. A system according to claim 2, wherein the peripheral comprises at least one microphone.

4. A system according to claim 2, wherein at least one of the first data and the second data is further based on data from at least one other slave device received via the frame sync input.

5. A system according to claim 1, wherein at least one slave device further comprises a processor configured to process data from the slave device and data received via the frame sync input.

6. A system according to claim 1, wherein the frame sync input of the first slave device in the chain configuration is coupled to the frame sync output of a last slave device in the daisy-chain configuration, and wherein the first slave device is configured to selectively receive, via its frame sync input, data transmitted on the frame sync output of the last slave device.

7. A system according to claim 6, wherein a frame sync output of the master device is coupled to the frame sync input of the first slave device and is further coupled to the frame sync output of the last slave device, and wherein the master device is configured to selectively receive, via its frame sync output, data transmitted on the frame sync output of the last slave device.

8. A system according to claim 1, wherein the frame sync output of the first slave device in the chain configuration is coupled to the frame sync output of the last slave device in the daisy-chain configuration, and wherein the first slave device is configured to selectively receive, via its frame sync output, data transmitted on the frame sync output of the last slave device and to selectively transmit data received from the last slave device to the master device.

9. A system according to claim 8, wherein the frame sync input of the second slave device in the daisy-chain configuration is coupled to the frame sync output of the first slave device and is further coupled to the frame sync output of the last slave device, and wherein the second slave device is configured to selectively receive, via its frame sync input, data transmitted on the frame sync output of the last slave device.

10. A system according to claim 1, wherein each slave device is configured to selectively receive, via its frame sync input, data transmitted on the frame sync output of the previous device in the daisy-chain configuration.

11. A system according to claim 1, wherein the master device is coupled to the frame sync output of the last slave device, and wherein the master device is configured to selectively transmit, via its frame sync output, data received from the frame sync output of the last slave device.

12. A slave device for operation in a time-division multiplexed communication system having a master device and a plurality of slave devices interconnected in a daisy-chain configuration and having a data line coupled to the master device and to each of the slave devices, the slave device comprising:
a data pin for coupling to the data line;
a frame sync output; and
a frame sync input for coupling to a frame sync output of a previous device in the daisy-chain configuration, wherein:
the slave device is configured to receive on its frame sync input a frame sync signal from the previous device in the daisy-chain configuration and to provide on its frame sync output a delayed frame sync signal;
the slave device is configured to transmit first data on the data line via its data pin in a predetermined time slot based on the frame sync signal received on its frame sync input; and
the slave device is configured to transmit second data on its frame sync output following transmission of the delayed frame sync signal.

13. A slave device according to claim 12, further comprising a peripheral, wherein at least one of the first data and the second data is based on data from the peripheral.

14. A slave device according to claim 13, wherein the peripheral comprises at least one microphone.

15. A slave device according to claim 12, wherein the slave device is configured to selectively receive, via its frame sync input, data transmitted on the frame sync output of the previous device in the daisy-chain configuration.

16. A slave device according to claim 15, wherein at least one of the first data and the second data is further based on data received via the frame sync input.

17. A slave device according to claim 15, further comprising a processor configured to process data from the slave device and data received via the frame sync input.

18. A slave device according to claim 12, wherein the frame sync input of the slave device is couplable to the frame sync output of a last slave device in the daisy-chain configuration, and wherein the slave device is configured to selectively receive, via its frame sync input, data transmitted on the frame sync output of the last slave device.

19. A slave device according to claim 12, wherein the frame sync output of the slave device is couplable to the frame sync output of a last slave device in the daisy-chain configuration, and wherein the slave device is configured to selectively receive, via its frame sync output, data transmitted on the frame sync output of the last slave device and to selectively transmit data received from the last slave device to the master device.

20. A master device for operation in a time-division multiplexed communication system having the master device and a plurality of slave devices interconnected in a daisy-chain configuration and having a data line coupled to the master device and to each of the slave devices, the master device comprising:
a data pin couplable to the data line; and
a frame sync output couplable to a frame sync input of a first slave device in the daisy-chain configuration, wherein the master device is configured to transmit a frame sync signal on its frame sync output, and wherein at least one of:
the master device is further configured to transmit data for at least one slave device via its frame sync output following the frame sync signal; or
the master device is further configured to selectively receive, via its frame sync output, data transmitted on a frame sync output of a last slave device in the daisy-chain configuration coupled to the frame sync output of the master device.

21. A master device according to claim 20, further comprising an input separate from the frame sync output and couplable to the frame sync output of the last slave device, wherein the master device is configured to receive data from the last slave device via the input and to selectively transmit the data via its frame sync output.
